(19) United States
(12) Patent Application Publication
(10) Pub. No.: US 2005/0017401 A1
(43) Pub. Date: Jan. 27, 2005

(54) Continuous process for producing a non-woven fabric from filaments stretched by calendaring

(76) Inventor: Yao-Chang Lin, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/627,901

(22) Filed: Jul. 25, 2003

(51) Int. Cl. B29C 47/00

(52) U.S. Cl. 264/211.22; 264/518; 425/83.1; 425/131.5

(57) ABSTRACT

A process of producing a non-woven fabric includes the steps of extruding a fiber forming resin through a spinneret to form filaments, passing the filaments through a cooling device, passing the filaments through a set of first rollers, passing the filaments through a heating device, stretching the filaments by passing the filaments through a set of second rollers, which operates at a speed greater than that of the first rollers, and forming the filaments into the non-woven fabric on a conveyor screen belt which advances in a longitudinal direction.

### BACKGROUND OF THE INVENTION

1. Field of the Invention

The invention relates to a process of making a non-woven fabric, more particularly to a continuous process for forming a non-woven fabric from filaments stretched by calendering.

2. Description of the Related Art

Referring to FIG. 1, a typical non-woven fabric 1 generally has fiber strands 11 which extend longitudinally such that it has insufficient bonding force along a transverse direction. Although the non-woven fabric 1 can endure longitudinal pulling forces and possesses high longitudinal tensile strength, it is liable to break or tear when subjected to transverse pulling forces.

In order to alleviate such a problem, the prior art has suggested an apparatus and a method, in which an air jet 32 is disposed close to fiber strands 31 which are extruded from a spinneret 2 to flow at a rate which is greater than the rate of extruding the fiber strands 31 (see FIG. 2). The air jet 32 causes the fiber strands 31 to swing randomly so that the fiber strands 31 are bent and interlace each other, thereby increasing the bonding force between fiber strands 31. However, although the flow rate of the air jet 32 must be greater than that of the fiber strands 31 so as to bend or turn the same, the flow rate must not be very high. Otherwise, the linear air jet 32 will provide a drawing force to pull the fiber strands 31 downward, which adversely affects the turning or bending of the fiber strands 31. In addition, since the extruding rate of the fiber strands 31 varies depending on the material thereof, it is difficult to precisely control the rates of the air jet 32 and the fiber strands 31.

It is known in the art to stretch the fiber strands or filaments exiting from a spinneret by employing a calendering process so as to align the molecules of the fiber strands or filaments and to enhance the tensile strength thereof. However, the fiber strands or filaments, after being subjected to the calendering process, are usually wound up by a wind-up roller rather than formed directly into a non-woven fabric on a screen belt since the wound up fibers or filaments do not have adhesion properties for bonding with each other. The wound up fibers or filaments are then subjected to subsequent processes, such as, chopping and forming by using a binder, or, weaving or knitting which produces a woven or knitted fabric. In other words, the conventional process for producing a non-woven fabric is not continuous if the fibers or filaments exiting from a spinneret undergo stretching by means of a calendering apparatus. The discontinuous process, as such, is laborious and time consuming. Moreover, the production rate thereof is low.

### SUMMARY OF THE INVENTION

Therefore, an object of the present invention is to provide an economical continuous process in which the fibers or filaments exiting from a spinneret are calendered and stretched and thereafter formed directly into a non-woven fabric on a screen belt.

According to one aspect of this invention, a process of producing a non-woven fabric comprises the steps of: extruding a fiber forming resin through a spinneret to form filaments; passing the filaments through a cooling device; passing the filaments through a set of first rollers; passing the filaments through a heating device; stretching the filaments by passing the filaments through a set of second rollers, which operates at a speed greater than that of said first rollers; and forming the filaments into the non-woven fabric on a conveyor screen belt which advances in a longitudinal direction.

According to another aspect of this invention, an apparatus for making a non-woven fabric comprises a spinneret having a plurality of extrusion holes for forming and extruding filaments, a cooling device disposed downstream of the spinneret for cooling the filaments that exit from the spinneret, a set of first rollers disposed downstream of the cooling device for drawing the filaments from the spinneret, a heating device disposed downstream of the first rollers for reheating the filaments, a set of second rollers disposed downstream of the heating device for drawing further the filaments from the first rollers, and a conveyor screen belt disposed downstream of the drawing air jet device for forming and advancing the filaments in a longitudinal direction. The second rollers operate at a speed greater than that of the first rollers.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a typical non-woven fabric;

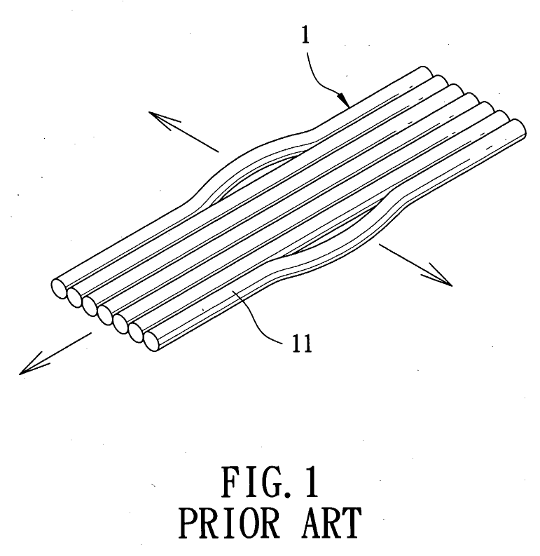

FIG. 2 is a perspective view to illustrate a conventional process of producing a non-woven fabric;

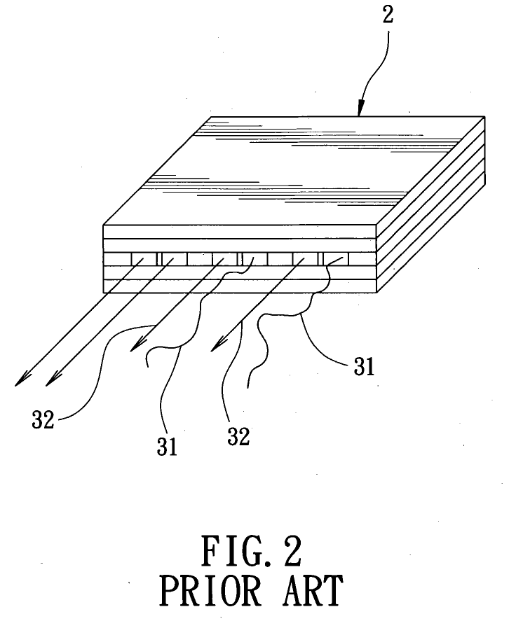

FIG. 3 is a schematic view of an apparatus for making a non-woven fabric according to the present invention, viewed in a direction transverse to a screen belt;

FIG. 4 is a schematic view of the apparatus of the present invention, viewed in a longitudinal direction of the screen belt;

FIG. 5 is a fragmentary perspective view of the apparatus of the present invention, illustrating a swinging air jet device with a plurality of swinging louvers;

FIG. 6 is a schematic view, illustrating filaments formed into wavy patterns according to the present invention, which overlap and interlace each other; and

FIG. 7 is a schematic view, illustrating an alternative implementation of the apparatus of the present invention.

### DETAILED DESCRIPTION OF THE PREFERRED EMBODIMENT

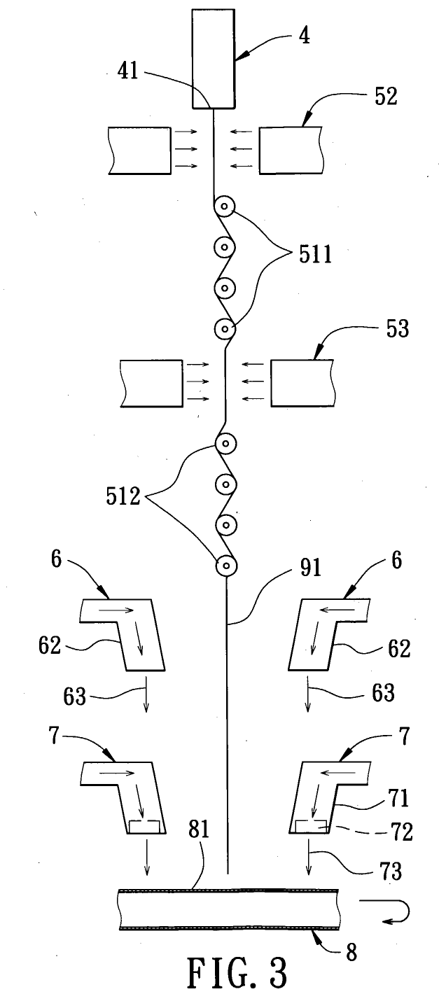

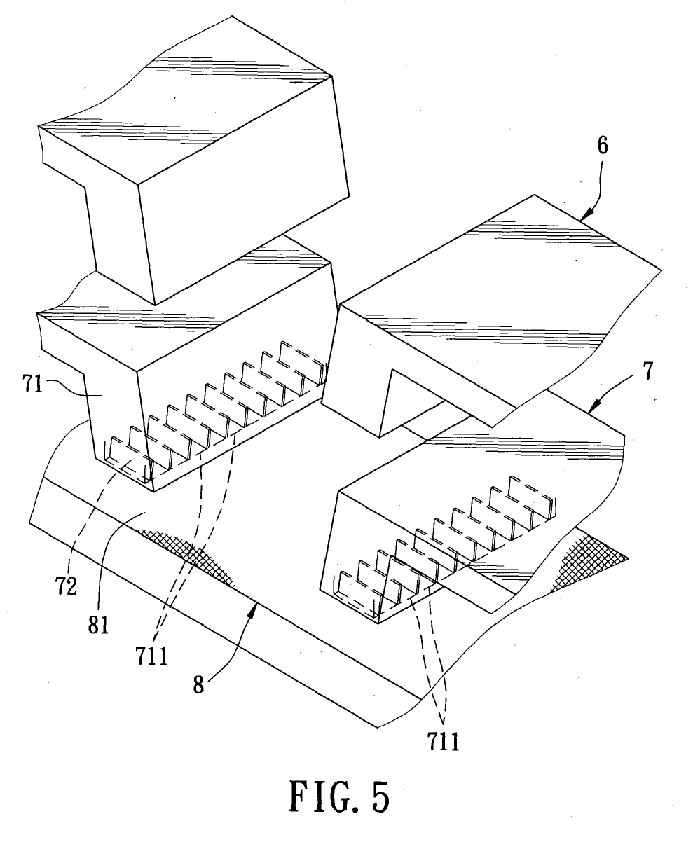

Referring to FIGS. 3, 4 and 5, a process of producing a non-woven fabric embodying the present invention is conducted through an apparatus (A) which comprises a spinneret 4, a set of first rollers 511, a cooling device 52, a heating device 53, a set of second rollers 512, a drawing air jet device 6, a swinging air jet device 7, and a conveyor screen belt 8.

The spinneret 4 has a plurality of extrusion holes 41 for forming and extruding filaments 91.

The cooling device 52 is disposed downstream of the spinneret 4 to produce cooling air for cooling the filaments 91 that exit from the spinneret 4.

The first rollers 511 are arranged downstream of the cooling device 52 for drawing the filaments 91 from the spinneret 4.

The heating device 53 is disposed downstream of the first rollers 511 to produce hot air for reheating the filaments 91 that exit from the first rollers 511.

The second rollers 512 are disposed downstream of the heating device 53 for stretching the filaments 91 from the first rollers 511. The rotational speed of the second rollers 512 is greater than that of the first rollers 511.

The drawing air jet device 6 is disposed downstream of the second rollers 512, and includes nozzles 62 to produce air currents 63 directed toward the conveyor screen belt 8, and high pressure air currents 63 which flow downwardly below and at two sides of the second rollers 512 through opposite air nozzle units 62 so as to draw the filaments 91 downwardly.

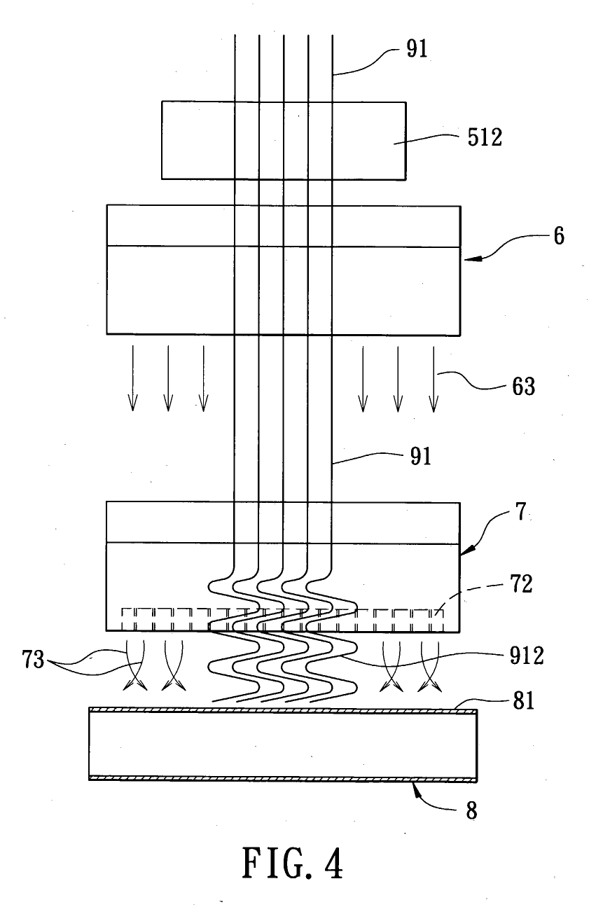

The swinging air jet device 7 is disposed downstream of the drawing air jet device 6 and upstream of the conveyor screen belt 8, and includes a pair of opposite nozzle units 71, which are respectively arranged below the nozzles 62 of the drawing air jet device 6 and each of which includes a nozzle outlet 711 that opens downwardly. A plurality of swinging louvers 72 are disposed at the nozzle outlet 711 of each nozzle unit 71, and are arranged in a row along a direction transverse to the longitudinal direction of the conveyor screen belt 8. The louvers 72 are swung transversely by a power means, such as a motor (not shown), so as to produce swinging air currents 73 (see FIG. 4).

The conveyor screen belt 8 is disposed downstream of the drawing and swinging air jet devices 6, 7 for forming and advancing the filaments 91 in a longitudinal direction. The conveyor screen belt 8 has a support face 81 facing toward the spinneret 4 and extending horizontally.

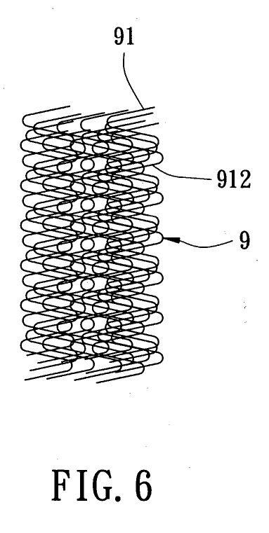

When the louvers 72 are actuated to move to-and-fro, swinging air currents 73 are produced, as shown in FIG. 4. The swinging air currents 73 cause the filaments 91 to swing to-and-fro in transverse directions, which are transverse to the longitudinal direction of the conveyor screen belt 8, so that the filaments 91 are formed into wavy patterns 912 which overlap and interlace each other, as shown in FIG. 6.

The continuous process according to the present invention is conducted as follows: First, a fiber forming resin, such as polypropylene or polyethylene, is melted and extruded through the extrusion holes 41 in the spinneret 4 to produce filaments 91. The filaments 91 are cooled by the cooling device 52, and are then passed through the first and second rollers 511, 512 and the heating device 53. The heating device 53 reheats the filaments 91. Since the rotational speed of the second rollers 512 is greater than that of the first rollers 511, the heated filaments 91 are stretched so as to align the molecules of the filaments 91, thereby increasing the tensile strength of the filaments 91.

After the stretched filaments 91 pass through the drawing air jet device 6, they are drawn downwardly by the air currents 63. The downwardly moving filaments 91 are blown by the swinging air currents 73 produced by the swinging air jet device 7 so that the filaments 91 are swung to-and-fro to form wavy patterns 912 which overlap and interlace each other in the transverse directions.

Finally, the downward filaments 91 are formed on the support face 81 of the conveyor screen belt 8, and are advanced longitudinally by the conveyor screen belt 8. As shown in FIG. 6, the wavy patterns 912 of the filaments 91 are entangled with each other and are superimposed one upon another, thereby forming a non-woven fabric 9, which is not only resistant to longitudinal pulling forces, but also has high transverse bonding strength.

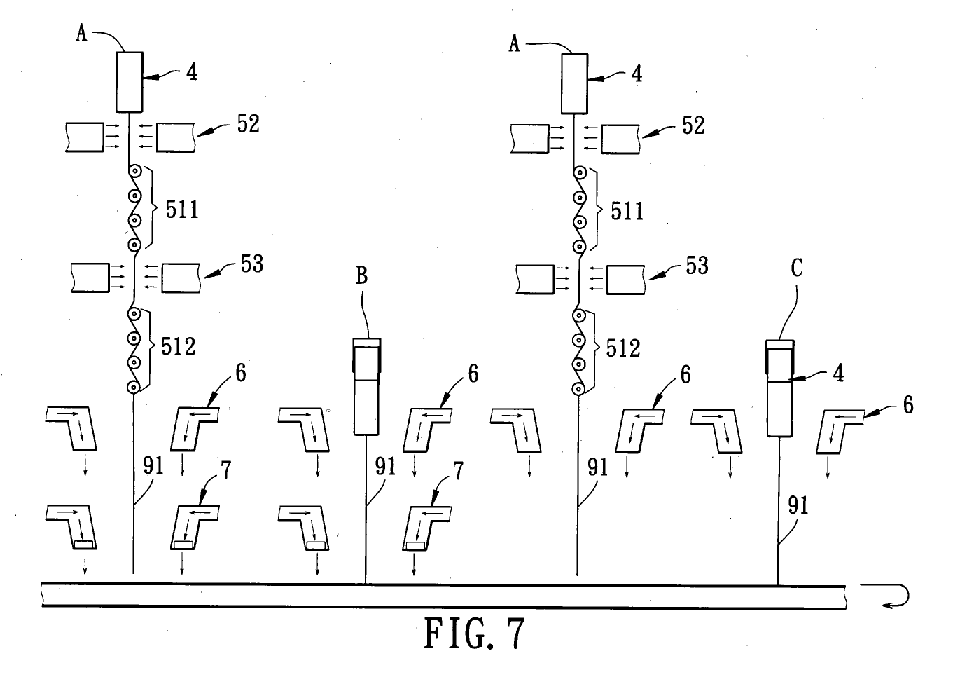

Referring to FIG. 7, a plurality of the apparatuses, specifically, two apparatuses (A), one apparatus (B), and one apparatus (C) are arranged in series along a longitudinal direction of a common conveyor screen belt 8 to fabricate a non-woven fabric (not shown) . The apparatus (B) is disposed between the apparatuses (A), and differs from the apparatus (A) in that the apparatus (B) is not provided with the first and second rollers 511, 512, the cooling device 52, and the heating device 53. The apparatus (C) differs from the apparatus (A) in that the apparatus (C) is only provided with the spinneret 4 and the drawing air jet device 6. The non-woven fabric as produced includes four fiber layers which are superimposed one above the other.

As described above, in the present invention, the high rotational speed of the second rollers 512 permits stretching of the filaments 91 so as to align the molecules of the filaments 91, thereby increasing the tensile strength of the filaments 91. Furthermore, the swinging air currents 73 produced by the swinging air jet device 7 cause the filaments 91 to form wavy patterns 912, which overlap and interlace each other, thereby increasing the transverse bonding strength of the non-woven fabric 9. As such, through the process and apparatus of the present invention, a non-woven fabric 9 with high longitudinal and transverse tensile strengths can be obtained. Precise control of the rates of the air currents and the filaments 91 is not needed in the present invention.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A process of producing a non-woven fabric, comprising:
(a) extruding a fiber forming resin through a spinneret to form filaments;
(b) passing the filaments through a cooling device;
(c) passing the filaments through a set of first rollers after step (b);
(d) passing the filaments through a heating device after step (c);
(e) stretching the filaments by passing the filaments through a set of second rollers after step (d), said second rollers operating at a speed greater than that of said first rollers; and
(f) forming the filaments into the non-woven fabric on a conveyor screen belt which advances in a longitudinal direction.

2. The process as claimed in claim 1, further comprising drawing the filaments by using a drawing air jet device before step (f).

3. The process as claimed in claim 2, further comprising using a swinging air jet device to swing the filaments to-and-fro downstream of the drawing air jet device, upstream of the conveyor screen belt and in transverse directions which are transverse to the longitudinal direction so that the filaments are formed into wavy patterns which overlap and interlace each other in the transverse directions.

4. The process as claimed in claim 3, wherein the swinging air jet device is used to produce swinging air currents to blow the filaments, said swinging air jet device having a plurality of swinging louvers.

5. An apparatus for making a non-woven fabric, comprising:
a spinneret having a plurality of extrusion holes for forming and extruding filaments;
a cooling device disposed downstream of said spinneret for cooling the filaments that exit from said spinneret;
a set of first rollers disposed downstream of said cooling device for drawing the filaments from said spinneret;
a heating device disposed downstream of said first rollers for reheating the filaments;
a set of second rollers disposed downstream of said heating device for drawing further the filaments from said first rollers, said second rollers operating at a speed greater than that of said first rollers; and
a conveyor screen belt disposed downstream of said drawing air jet device for forming and advancing the filaments in a longitudinal direction.

6. The apparatus as claimed in claim 5, further comprising a drawing air jet device disposed downstream of said second rollers for drawing the filaments.

7. The apparatus as claimed in claim 6, further comprising a swinging air jet device disposed downstream of said drawing air jet device and upstream of said conveyor screen belt for swinging the filaments to-and-fro in transverse directions which are transverse to the longitudinal direction, wherein the filaments are formed into wavy patterns which overlap and interlace each other in the transverse directions.

8. The apparatus as claimed in claim 7, wherein said swinging air jet device includes a plurality of swinging louvers to produce swinging air currents.

9. The apparatus as claimed in claim 7, wherein said swinging air jet device includes a nozzle outlet, and a plurality of swinging louvers disposed at said nozzle outlet, said swinging louvers being arranged in a row along a direction transverse to the longitudinal direction.
